(19) United States
(12) Patent Application Publication
(10) Pub. No.: US 2026/0322012 A1
(43) Pub. Date: Oct. 15, 2026

(54) WIRE-ROUTING MODULE

(71) Applicant: Yazaki Corporation, Tokyo (JP)

(72) Inventors: Masayoshi TAKAYANAGI, Shizuoka (JP); Sadaharu OKUDA, Shizuoka (JP); Hikaru SANO, Shizuoka (JP); Koki ADACHI, Shizuoka (JP); Ryoichi MURATA, Shizuoka (JP)

(73) Assignee: Yazaki Corporation, Tokyo (JP)

(21) Appl. No.: 19/646,790

(22) Filed: Apr. 14, 2026

(30) Foreign Application Priority Data
Apr. 15, 2025 (JP) 2025-066671

(51) Int. Cl. H01R 12/77; H01M 50/298

(52) U.S. Cl. CPC H01R 12/771; H01M 50/298

(57) ABSTRACT

A wire-routing module includes: a flat routing member having flexibility and including a trunk portion extending along an extending direction of a battery module, and an excess-length portion connected to the trunk portion via a bent portion; a connector mounted on a connector mounting surface provided in the excess-length portion; and a lower cover and an upper cover assembled to each other with the flat routing member interposed therebetween, the lower cover and the upper cover integrally covering the excess-length portion and the bent portion and suppressing the penetration of condensation generated in the battery module into the connector mounting surface side.

### CROSS-REFERENCE TO RELATED APPLICATION(S)

The present application claims priority to and incorporates by reference the entire contents of Japanese Patent Application No. 2025-066671 filed in Japan on Apr. 15, 2025.

### BACKGROUND OF THE INVENTION

### 1. Field of the Invention

The present invention relates to a wire-routing module.

### 2. Description of the Related Art

As an example of a conventional technology relating to a wire-routing module, Japanese Patent Application Laid-open No. JP 2019-192 336 A discloses a wiring module including a flat electric wire attached to a group of power-storage elements in which a plurality of power-storage elements are integrated, and a wire-side connector that is connected to an end of the flat electric wire and that is fitted to an equipment-side connector provided on a control unit of the power-storage-element group. The flat electric wire includes an excess-length portion extending from the group of power storage elements, and a bend-restricting plate is laminated on a part of the excess-length portion.

In the above-mentioned conventional wiring module, for example, although the flat electric wire is provided with an excess-length portion, there is room for further improvement in appropriately protecting the excess-length portion.

### SUMMARY OF THE INVENTION

In view of the foregoing circumstances, the present invention is intended to provide a wire-routing module capable of appropriately protecting an excess-length portion.

In order to achieve the above mentioned object, a wire-routing module according to one aspect of the present invention includes a flat routing member having flexibility and including a trunk portion and an excess-length portion, the trunk portion extending along an extending direction of a battery module, and the excess-length portion being connected to the trunk portion via a bent portion; a connector mounted on a connector mounting surface provided in the excess-length portion; and a lower cover and an upper cover assembled to each other with the flat routing member interposed between the lower cover and the upper cover, the lower cover and the upper cover integrally covering the excess-length portion and the bent portion and suppressing the penetration of condensation generated in the battery module into the connector mounting surface side.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a wire-routing module according to an embodiment;

FIG. 2 is an exemplary perspective view of a battery module to which a wire-routing module according to an embodiment is applied;

FIG. 3 is an exemplary exploded perspective view of a wire-routing module according to an embodiment;

FIG. 4 is an exemplary cross-sectional view (YZ cross-sectional view) of a wire-routing module according to an embodiment;

FIG. 5 is an exemplary cross-sectional view (XZ cross-sectional view) of a wire-routing module according to an embodiment; and

FIG. 6 is an exemplary enlarged cross-sectional view in the vicinity of a labyrinth passage of a wire-routing module according to a modification.

### DETAILED DESCRIPTION OF THE PREFERRED EMBODIMENTS

Embodiments and modifications according to the present invention are described in detail below with reference to the drawings. Note that the embodiments and modifications described below do not limit the present invention. Furthermore, the constituent elements in the embodiments and modifications include elements that can be substituted by those that are readily replaced by a person skilled in the art, or those that are substantially identical.

Further, the embodiments and modifications disclosed below include similar constituent elements. Accordingly, in the following description, similar constituent elements are denoted by common reference numerals, and redundant description will be omitted. It is noted that ordinal numbers used herein are merely employed to distinguish parts, members, portions, positions, directions, and the like, and do not indicate order or priority.

### Embodiment

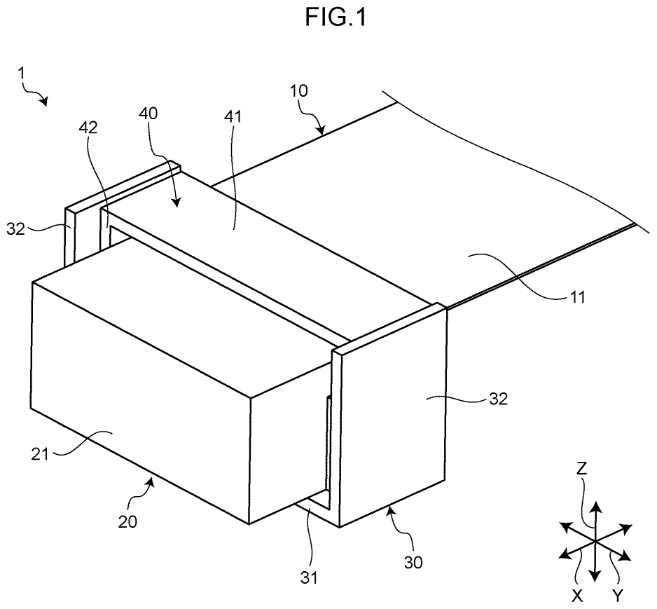

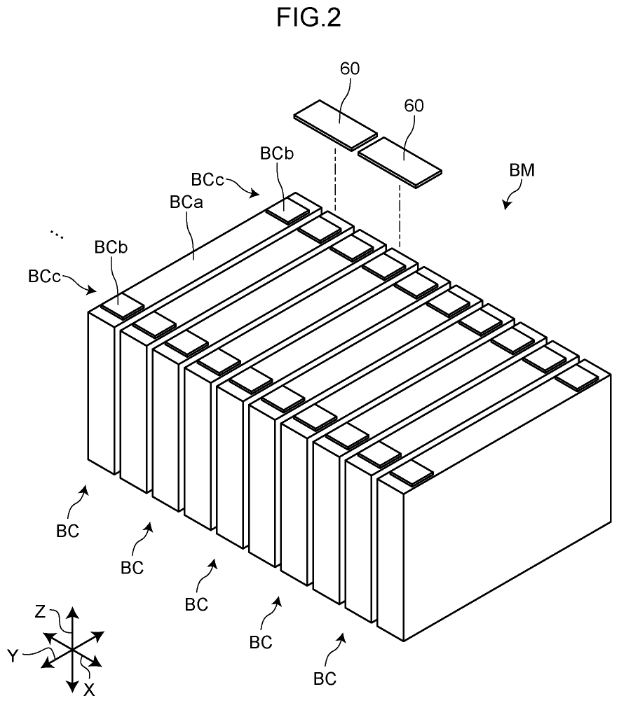

FIG. 1 is a perspective view of a wire-routing module 1 according to an embodiment. The wire-routing module 1 according to the present embodiment illustrated in FIG. 1 is, for example, assembled to a battery module BM in which a plurality of battery cells BC (see FIG. 2) are arranged, and is electrically connected to the plurality of battery cells BC of the battery module BM. Further, by electrically connecting the battery module BM to a battery monitoring unit via a connector 20, the wire-routing module 1 allows the battery monitoring unit to monitor the battery states of the battery cells BC. The wire-routing module 1 constitutes a battery pack together with the battery module BM. The battery pack is mounted, for example, in a vehicle (such as a battery electric vehicle (BEV) or a hybrid electric vehicle (HEV)) equipped with an electric rotating machine as a drive source, and is used to supply electric power to the electric rotating machine.

In the following description, for the first, second, and the third directions that intersect each other, the first direction is referred to as an “extending direction X”, the second direction is referred to as a “width direction Y”, and the third direction is referred to as a “height direction Z”. Here, the extending direction X, the width direction Y, and the height direction Z are substantially orthogonal to each other. The extending direction X typically corresponds to the extending (longitudinal) direction of the wire-routing module 1, the extending (longitudinal) direction of the battery module BM, the arrangement direction of the plurality of battery cells BC, or the like. The width direction Y typically corresponds to the width (lateral) direction of the wire-routing module 1, the battery module BM, or the like. The height direction Z typically corresponds to the height (vertical) direction of the wire-routing module 1 and the battery module BM, the assembly direction of a lower cover 30 and an upper cover 40 described below, or the like. Note that unless otherwise specified, each direction used in the following description refers to the directions in a state where the wire-routing module 1 is assembled to the battery module BM.

FIG. 2 is a perspective view of the battery module BM to which the wire-routing module 1 is applied. As illustrated in FIG. 2, the battery module BM includes, for example, the plurality of battery cells BC and a case (not illustrated) that accommodates the plurality of battery cells BC. Each battery cell BC includes, for example, a cell body BCa and a pair of positive and negative electrode terminals BCb. In the battery module BM, the plurality of battery cells BC are arranged in a single row along the extending direction X. The battery module BM has one electrode terminal group BCc, in which the electrode terminals BCb of the plurality of battery cells BC are arranged along the extending direction X on one end side in the width direction Y, and has the other electrode terminal group BCc, in which the electrode terminals BCb of the plurality of battery cells BC are arranged along the extending direction X on the other end side in the width direction Y.

Each battery cell BC has, for example, the cell body BCa formed in a rectangular parallelepiped shape having six outer wall surfaces. The plurality of battery cells BC are arranged such that the cell bodies BCa adjacent in the extending direction X face each other with one of their outer wall surfaces. For example, in each battery cell BC, the positive and negative electrode terminals BCb are disposed on one of the six outer wall surfaces of the cell body BCa or separately arranged on two of the six outer wall surfaces of the cell body BCa. Here, each battery cell BC includes the positive and negative electrode terminals BCb on one of the six outer wall surfaces of the cell body BCa. Accordingly, in the battery module BM, two groups of electrode terminal groups BCc are provided on one outer wall surface.

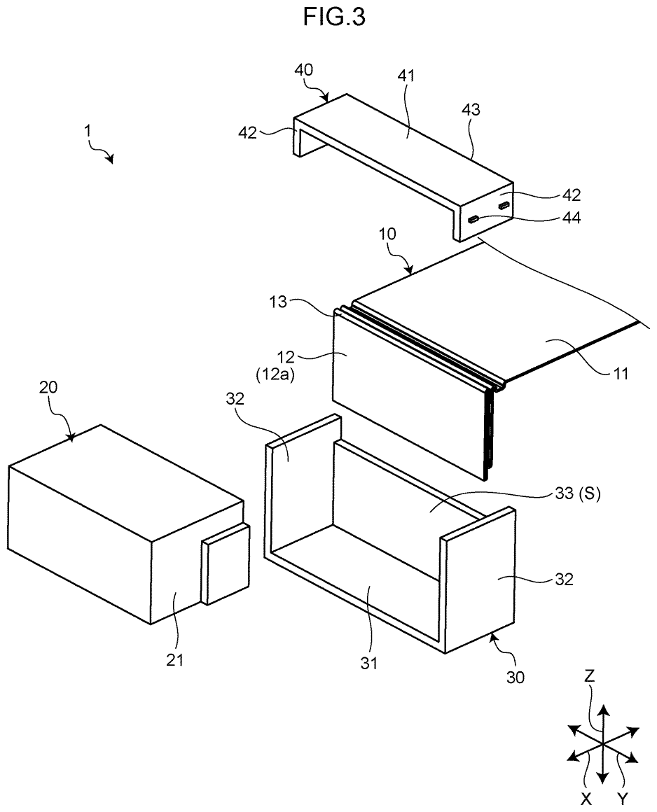

Each electrode terminal BCb is formed, for example, into a flat-plate shape and is directly and electrically connected to a busbar 60 by laser welding or the like. However, the electrode terminals BCb may be formed into a pole shape having a male-thread portion. In such a case, the busbar 60 is fastened to the electrode terminal BCb by screwing a female-thread member onto the male-thread portion of the electrode terminal BCb. The busbar 60 is electrically connected to the electrode terminals BCb of the battery cells BC constituting the battery module BM. The busbar 60 is a plate-like conductive component made of metal, and is formed, for example, by press-forming a metal plate as a base material. The busbar 60 illustrated here is formed into a rectangular flat plate shape. The busbar 60 electrically connects the electrode terminal BCb to a flat routing member 10 (see FIG. 3) of the wire-routing module 1.

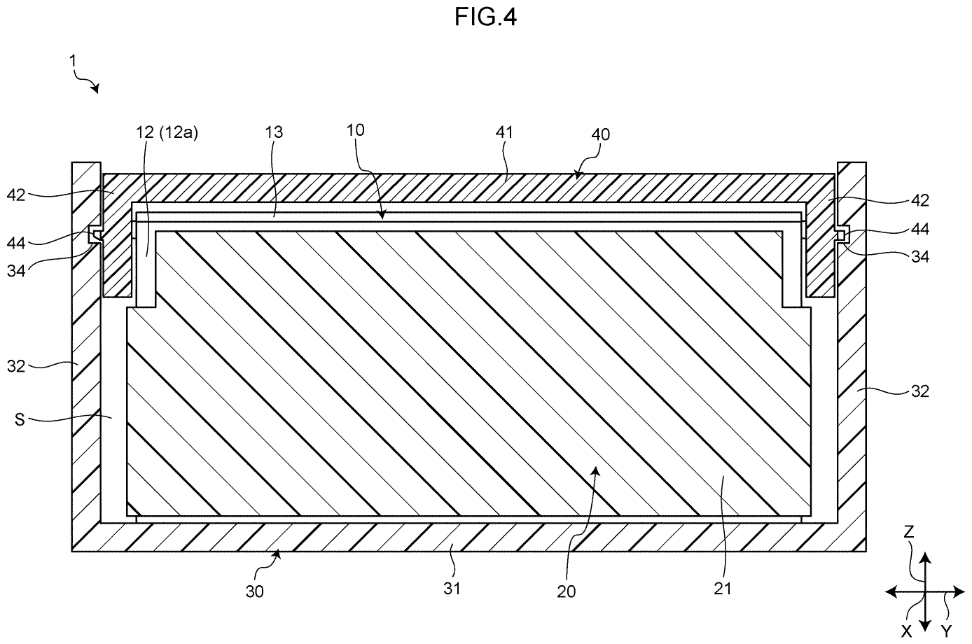

FIG. 3 is an exploded perspective view of the wire-routing module 1, and FIG. 4 is a cross-sectional view (YZ cross-sectional view) of the wire-routing module 1. As illustrated in FIGS. 3 and 4, the wire-routing module 1 includes, for example, the flat routing member 10, the connector 20, a lower cover 30, and an upper cover 40. The flat routing member 10 is a routing member that constitutes a wire harness, and is formed, for example, from a flexible printed circuit (FPC), a flexible flat cable (FFC), or the like. The flat routing member 10 is a flat routing member that is thin along the height direction Z and has flexibility (bendability).

The flat routing member 10 includes, for example, a trunk portion 11 and an excess-length portion 12. The trunk portion 11 is a portion of the flat routing member 10 that is formed into a rectangular flat-plate shape extending in a laterally elongated manner along the extending direction X. The trunk portion 11 is mounted on the outer wall surface on which the electrode terminals BCb of the plurality of battery cells BC constituting the above-described battery module BM are provided. The excess-length portion 12 is connected to the trunk portion 11 via a bent portion 13. The excess-length portion 12 is provided at one end of the trunk portion 11 in the extending direction X and is folded along the height direction Z via the bent portion 13. The excess-length portion 12 is positioned to overlap with one end side of the plurality of battery cells BC constituting the above-described battery module BM along the extending direction X.

Further, the flat routing member 10 includes, for example, a base film, a wiring pattern, and a coverlay. The base film is a base material having excellent flexibility and defining the overall shape of the flat routing member 10. The base film is formed, for example, of a polyimide resin having excellent heat resistance. The wiring pattern is laminated on the surface of the base film and constitutes a plurality of conductor circuit portions (pattern layers). The wiring pattern is formed, for example, of a conductive material such as copper foil, and is printed on the surface of the base film as a printed circuit body. The coverlay is laminated on the surface of the base film via an adhesive or the like and functions as a protective layer that protects the conductor circuit portions of the wiring pattern.

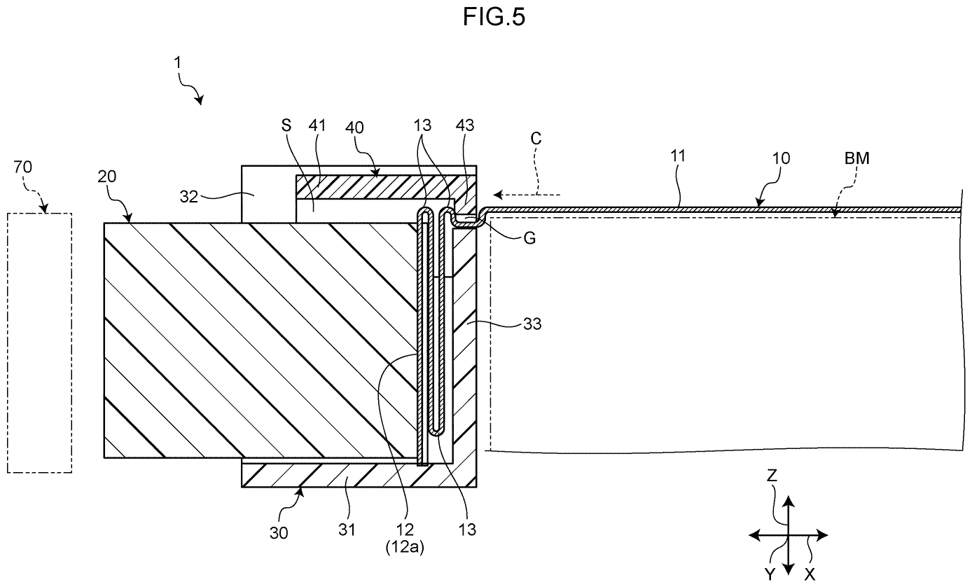

The connector 20 includes, for example, a plurality of connector terminals (not illustrated) and a connector housing 21 that accommodates the plurality of connector terminals, and is electrically connected to a mating connector 70 (see FIG. 5) of a battery monitoring unit that monitors the battery states of the above-described battery cells BC. The connector 20 is mounted on, for example, a connector mounting surface 12a provided on one end surface of the excess-length portion 12 in the extending direction X, and is electrically connected to the wiring pattern of the flat routing member 10. The plurality of conductor circuit portions constituting the wiring pattern can each function as, for example, a signal circuit, a signal-GND circuit, a power-ground circuit, or the like. The signal circuit is, for example, a circuit that transmits a communication signal between the battery cells BC and the battery monitoring unit. The signal-GND circuit is a circuit that conducts between the battery cells BC and the battery monitoring unit together with the signal circuit and aligns a reference potential that serves as a basis for circuit operation. The power-ground circuit is a circuit that grounds a power supply system between the battery cells BC and the battery monitoring unit.

The lower cover 30 covers, for example, the excess-length portion 12 and the bent portion 13 of the flat routing member 10 from the other end side (bottom side) in the height direction Z. The lower cover 30 includes, for example, a lower-cover-bottom wall 31, a pair of lower-cover-side walls 32, and a lower-cover-side end wall 33. The lower-cover-bottom wall 31, the pair of lower-cover-side walls 32, and the lower-cover-side end wall 33 constitute a structure that partitions an accommodation space S (see FIG. 4) of the lower cover 30. The accommodation space S is a space in which the excess-length portion 12 and the bent portion 13 of the flat routing member 10 are accommodated.

The lower-cover-bottom wall 31 is a portion facing the other end (lower end) of the excess-length portion 12 in the height direction Z, and is formed into a substantially rectangular flat-plate shape extending laterally along the width direction Y. The pair of lower-cover-side walls 32 are provided at both ends of the lower-cover-bottom wall 31 in the width direction Y and protrude from the lower-cover-bottom wall 31 toward the one end side (upper side) in the height direction Z. The pair of lower-cover-side walls 32 face both ends of the excess-length portion 12 in the width direction Y. The lower-cover-side end wall 33 is provided at the other end (the end opposite the connector 20) of the lower-cover-bottom wall 31 in the extending direction X and protrudes from the lower-cover-bottom wall 31 toward one end side (upper side) in the height direction Z. The lower-cover-side end wall 33 faces the other end surface of the excess-length portion 12 in the extending direction X (the end surface opposite to the connector mounting surface 12a). The lower cover 30 is formed, for example, of an insulating resin material.

The upper cover 40 covers, for example, the excess-length portion 12 and the bent portion 13 of the flat routing member 10 from the one end side (upper side) in the height direction Z. The upper cover 40 includes, for example, an upper-cover-bottom wall 41, a pair of upper-cover-side walls 42, and an upper-cover-side end wall 43. The upper-cover-bottom wall 41, the pair of upper-cover-side walls 42, and the upper-cover-side end wall 43 constitute a structure that partitions, together with the above-described lower cover 30, the accommodation space S (see FIG. 4). The accommodation space S is a space in which the excess-length portion 12 and the bent portion 13 of the flat routing member 10 are accommodated.

The upper-cover-bottom wall 41 is a portion facing the one end (upper end) of the excess-length portion 12 in the height direction Z, and is formed into a substantially rectangular flat-plate shape extending laterally along the width direction Y. The pair of upper-cover-side walls 42 are provided at both ends of the upper-cover-bottom wall 41 in the width direction Y and protrude from the upper-cover-bottom wall 41 toward the other end side (lower side) in the height direction Z. The pair of upper-cover-side walls 42 face both ends of the excess-length portion 12 in the width direction Y. The upper-cover-side end wall 43 (see FIG. 5) is provided at the other end (the end opposite the connector 20) of the upper-cover-bottom wall 41 in the extending direction X and protrudes from the upper-cover-bottom wall 41 toward the other end side (lower side) in the height direction Z. In the present embodiment, a gap G through which the excess-length portion 12 is inserted along the extending direction X is provided between the upper-cover-side end wall 43 and the lower-cover-side end wall 33. The upper cover 40 is formed, for example, of an insulating resin material.

The lower cover 30 and the upper cover 40 are assembled to each other along the height direction Z with the flat routing member 10 interposed therebetween, and are integrated with each other by a locking structure using a locking portion. The locking portion locks the upper cover 40 relative to the lower cover 30. The locking portion includes, for example, a claw-shaped male lock 44 (see FIG. 3) provided on the side of the upper cover 40, and a hole-shaped female lock 34 (see FIG. 4) provided on the side of the lower cover 30. The male lock 44 is formed in a claw shape on the outer surface of the pair of upper-cover-side walls 42, and the female lock 34 is formed in a hole shape on the inner surface of the pair of lower-cover-side walls 32. The locking portion restricts movement of the upper cover 40 relative to the lower cover 30 along the height direction Z by engaging the male lock 44 and the female lock 34 with each other along the height direction Z.

FIG. 5 is a cross-sectional view (XZ cross-sectional view) of the wire-routing module 1. As illustrated in FIG. 5, in the present embodiment, the excess-length portion 12 is accommodated within the accommodation space S between the lower cover 30 and the upper cover 40 in a state of being folded into an expandable and contractible shape along the extending direction X via the bent portion 13. Specifically, the excess-length portion 12 is provided, for example, with the plurality of bent portions 13 arranged at intervals along the extending direction X, and is folded into a bellows shape (accordion shape) that is expandable and contractible along the extending direction X via the plurality of bent portions 13. In other words, the excess-length portion 12 includes a plurality of linear portions that are arranged at intervals along the extending direction X and extend along the height direction Z, and a plurality of curved bent portions 13 that connect the plurality of linear portions to each other along the extending direction X.

Then, in the present embodiment, the connector 20 is mounted on the connector mounting surface 12a, which is one end surface of the excess-length portion 12 in the extending direction X, and is configured to be slidable along the extending direction X within the accommodation space S in accordance with expansion and contraction of the excess-length portion 12 along the extending direction X. In other words, the connector 20 is accommodated in the accommodation space S in a state of being relatively movable along the extending direction X with respect to the lower cover 30 and the upper cover 40. Moreover, in FIG. 5, for example, a state is illustrated in which the connector 20 and the excess-length portion 12 are pushed toward the other end side (the lower-cover-side end wall 33 side) in the extending direction X by an operator's fingers or the like, and when the operator's fingers or the like are released, the connector 20 and the excess-length portion 12 expand toward the one end in the extending direction X. This enables the absorption of tolerance in the extending direction X between the connector 20 and the mating connector 70 of the battery monitoring unit that monitors the battery states of the above-described battery cells BC.

Further, in the present embodiment, the lower cover 30 and the upper cover 40 integrally cover the excess-length portion 12 and the bent portion 13, thereby suppressing penetration of condensation C generated in the battery module BM into the connector mounting surface 12a side. Here, since the battery module BM includes the plurality of battery cells BC that are heat-generating components, the condensation C may be generated, for example, due to a temperature difference between the inside and the outside of the case that integrally accommodates the plurality of battery cells BC in the battery module BM and the wire-routing module 1 together. If the lower cover 30 and the upper cover 40 that integrally cover the excess-length portion 12 and the bent portion 13 were not provided in the wire-routing module 1, there would be a risk of the condensation C generated due to the temperature difference between the inside and outside of the case of the battery module BM penetrating into the connector mounting surface 12a side. In this regard, in the present embodiment, since the wire-routing module 1 includes the lower cover 30 and the upper cover 40 that integrally cover the excess-length portion 12 and the bent portion 13, the wire-routing module 1 is capable of suppressing the penetration of the condensation C generated in the battery module BM into the connector mounting surface 12a side.

As described above, the wire-routing module 1 according to the present embodiment includes: the flat routing member 10 having flexibility and including the trunk portion 11 extending along the extending direction X of the battery module BM and the excess-length portion 12 connected to the trunk portion 11 via a bent portion 13; the connector 20 mounted on a connector mounting surface 12a provided in the excess-length portion 12; and the lower cover 30 and the upper cover 40 assembled to each other with the flat routing member 10 interposed therebetween, integrally covering the excess-length portion 12 and the bent portion 13, and suppressing the penetration of the condensation C generated in the battery module BM into the connector mounting surface 12a side. With this configuration, the lower cover 30 and the upper cover 40 enable the wire-routing module 1 to suppress interference between the excess-length portion 12 or the bent portion 13 and peripheral components (e.g., the case of the battery module BM), and also to suppress the penetration of the condensation C generated in the battery module BM into the connector mounting surface 12a side. As a result, the wire-routing module 1 is capable of properly protecting the excess-length portion 12.

Further, in the wire-routing module 1 according to the present embodiment, the excess-length portion 12 is accommodated in a folded state in which the excess-length portion 12 is foldable and extendable along the extending direction X via the bent portion 13 within the accommodation space S between the lower cover 30 and the upper cover 40, and the connector 20 is mounted on the connector mounting surface 12a, which is the end surface of the excess-length portion 12 in the extending direction X, and is configured to be slidable along the extending direction X within the accommodation space S in accordance with extension and contraction of the excess-length portion 12 along the extending direction X. With this configuration, the wire-routing module 1 is capable of appropriately absorbing, for example, a tolerance between the connector 20 and the mating connector 70 along the extending direction X by extension and contraction of the excess-length portion 12 along the extending direction X.

### Modifications

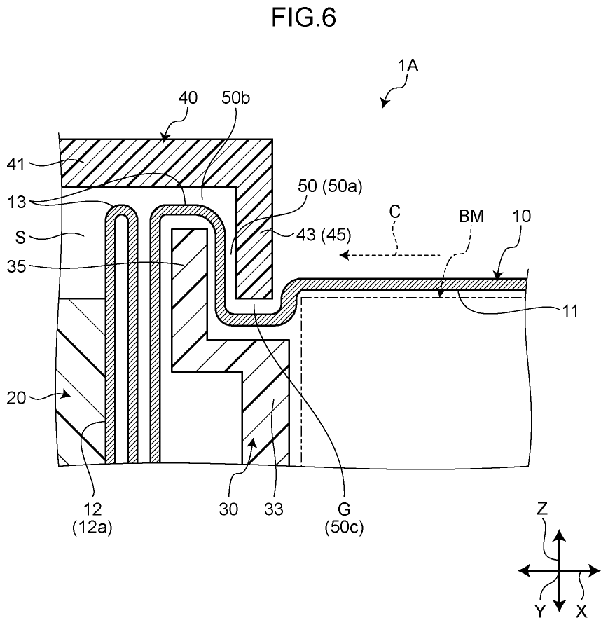

FIG. 6 is an enlarged cross-sectional view in the vicinity of a labyrinth passage 50 of a wire-routing module 1A according to a modification. The wire-routing module 1A illustrated in FIG. 6 includes a configuration similar to that of the wire-routing module 1 of the above-described embodiment. Accordingly, the wire-routing module 1A is capable of achieving functions and effects similar to those of the above-described embodiment based on such similar configuration.

However, in the present modification, as illustrated in FIG. 6, the labyrinth passage 50 is provided between a lower cover 30 and an upper cover 40, which differs from the above embodiment. Specifically, in the present modification, the lower cover 30 and the upper cover 40 are provided with a lower-cover-side lap portion 35 and an upper-cover-side lap portion 45, respectively, which overlap each other along the extending direction X.

The lower-cover-side lap portion 35 is provided, for example, at one end (upper end) in the height direction Z of the above-described lower-cover-side end wall 33, and protrudes in a crank shape toward one end in the extending direction X and toward the one end in the height direction Z from the end portion. The upper-cover-side lap portion 45 is provided, for example, at the above-described upper-cover-side end wall 43, and is located apart from the lower-cover-side lap portion 35 on the other end side in the extending direction X. The labyrinth passage 50 through which the excess-length portion 12 is inserted and which suppresses the penetration of the condensation C into the connector mounting surface 12a side is formed between the lower-cover-side lap portion 35 and the upper-cover-side lap portion 45.

The labyrinth passage 50 includes a first passage 50a, a second passage 50b, and a third passage 50c. The first passage 50a is a passage provided between the lower-cover-side lap portion 35 and the upper-cover-side lap portion 45 within the labyrinth passage 50, and extends along the height direction Z. The second passage 50b is a passage provided at one end in the height direction Z of the first passage 50a and extends along the extending direction X to communicate with the accommodation space S on the connector mounting surface 12a side. The third passage 50c is a passage provided at the other end in the height direction Z of the first passage 50a and extends along the extending direction X to communicate with an external space on the battery module BM side that serves as a penetration path for the condensation C. The labyrinth passage 50 defines a gap G through which the excess-length portion 12 is inserted in a crank shape along the extending direction X and the height direction Z.

In the present modification, for example, the condensation C generated by the temperature difference between the inside and outside of the case of the battery module BM penetrates from the third passage 50c side of the labyrinth passage 50 along the extending direction X. In this case, since the labyrinth passage 50 includes the first passage 50a extending along the height direction Z, the first passage 50a (the lower-cover-side lap portion 35) suppresses the penetration of the condensation C into the accommodation space S on the connector mounting surface 12a side along the extending direction X.

As described above, in the wire-routing module 1A of the present modification, the lower cover 30 and the upper cover 40 respectively include the lower-cover-side lap portion 35 and the upper-cover-side lap portion 45 that overlap each other along the extending direction X, and the labyrinth passage 50 is formed between the lower-cover-side lap portion 35 and the upper-cover-side lap portion 45, through which the excess-length portion 12 is inserted and which suppresses the penetration of the condensation C into the connector mounting surface 12a side. With this configuration, the wire-routing module 1A is capable of suppressing the penetration of the condensation C into the connector mounting surface 12a side through the gap G between the lower cover 30 and the upper cover 40, the gap G being defined by the labyrinth passage 50 through which the excess-length portion 12 is inserted.

Further, in the wire-routing module 1A of the present modification, the labyrinth passage 50 includes the first passage 50a provided between the lower-cover-side lap portion 35 and the upper-cover-side lap portion 45 and extending along the height direction Z, the second passage 50b provided at one end in the height direction Z of the first passage 50a and extending along the extending direction X to communicate with the accommodation space S on the connector mounting surface 12a side, and the third passage 50c provided at the other end in the height direction Z of the first passage 50a and extending along the extending direction X to communicate with the external space on the battery module BM side that serves as a penetration path for the condensation C. With this configuration, the wire-routing module 1A is capable of more reliably suppressing the penetration of the condensation C into the connector mounting surface 12a side by the first passage 50a, the second passage 50b, and the third passage 50c of the labyrinth passage 50.

Moreover, in the present modification and the above embodiment, although the lower cover 30 and the upper cover 40 are illustrated as being assembled to each other along the height direction Z, the present disclosure is not limited thereto, and the lower cover 30 and the upper cover 40 may alternatively be assembled to each other, for example, along the width direction Y. In addition, in the present modification and the above embodiment, although the lower cover 30 and the upper cover 40 are illustrated as being fixed to each other by the male lock 44 having a claw shape and the female lock 34 having a locking-hole shape, the present disclosure is not limited thereto, and the covers may alternatively be fixed to each other, for example, using fastening members such as a bolt.

Although the embodiment and the modification of the present invention have been described above, the above embodiment and modification are merely examples and are not intended to limit the scope of the invention. The embodiment and the modification can be implemented in various other forms, and various omissions, substitutions, combinations, and modifications may be made within a scope not departing from the gist of the invention. Furthermore, various specifications such as structures, types, directions, forms, sizes, lengths, widths, thicknesses, heights, numbers, arrangements, positions, and materials may be appropriately modified in implementation.

The wire-routing module according to the present embodiment provides the effect of appropriately protecting the excess-length portion.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire-routing module comprising:
a flat routing member having flexibility and including a trunk portion and an excess-length portion, the trunk portion extending along an extending direction of a battery module, and the excess-length portion being connected to the trunk portion via a bent portion;
a connector mounted on a connector mounting surface provided in the excess-length portion; and
a lower cover and an upper cover assembled to each other with the flat routing member interposed between the lower cover and the upper cover, the lower cover and the upper cover integrally covering the excess-length portion and the bent portion and suppressing the penetration of condensation generated in the battery module into the connector mounting surface side.

2. The wire-routing module according to claim 1, wherein
the excess-length portion is accommodated within an accommodation space between the lower cover and the upper cover in a folded state to be extendable and contractible along the extending direction via the bent portion, and
the connector is mounted on the connector mounting surface and is configured to be slidable along the extending direction within the accommodation space in accordance with extension and contraction of the excess-length portion along the extending direction, the connector mounting surface being an end surface of the excess-length portion in the extending direction.

3. The wire-routing module according to claim 1, wherein
the lower cover and the upper cover respectively include a lower-cover-side lap portion and an upper-cover-side lap portion that overlap each other along the extending direction, and
a labyrinth passage is provided between the lower-cover-side lap portion and the upper-cover-side lap portion, the labyrinth passage being configured to permit insertion of the excess-length portion and to suppress penetration of the condensation into the connector mounting surface side.

4. The wire-routing module according to claim 2, wherein
the lower cover and the upper cover respectively include a lower-cover-side lap portion and an upper-cover-side lap portion that overlap each other along the extending direction, and
a labyrinth passage is provided between the lower-cover-side lap portion and the upper-cover-side lap portion, the labyrinth passage being configured to permit insertion of the excess-length portion and to suppress penetration of the condensation into the connector mounting surface side.

5. The wire-routing module according to claim 3, wherein
the labyrinth passage includes:
a first passage provided between the lower-cover-side lap portion and the upper-cover-side lap portion and extending along a height direction intersecting the extending direction;
a second passage provided at one end of the first passage in the height direction and extending along the extending direction to communicate with an accommodation space on the connector mounting surface side; and
a third passage provided at the other end of the first passage in the height direction and extending along the extending direction to communicate with an external space on the battery module side that serves as a penetration path for the condensation.

6. The wire-routing module according to claim 4, wherein
the labyrinth passage includes:
a first passage provided between the lower-cover-side lap portion and the upper-cover-side lap portion and extending along a height direction intersecting the extending direction;
a second passage provided at one end of the first passage in the height direction and extending along the extending direction to communicate with the accommodation space on the connector mounting surface side; and
a third passage provided at the other end of the first passage in the height direction and extending along the extending direction to communicate with an external space on the battery module side that serves as a penetration path for the condensation.
